(19) United States
(12) Patent Application Publication
(10) Pub. No.: US 2023/0211567 A1
(43) Pub. Date: Jul. 6, 2023

(54) RESISTANCE REPAIR OF THERMOPLASTIC COMPONENTS

(71) Applicant: Rohr, Inc., Chula Vista, CA (US)

(72) Inventors: Noushin Bahramshahi, Mission Viejo, CA (US); Michael van Tooren, San Diego, CA (US); Daniel O. Ursenbach, Caledonia, IL (US)

(21) Appl. No.: 17/566,284

(22) Filed: Dec. 30, 2021

(51) Int. Cl. B29C 65/34; B29C 73/06; B29C 65/00

(52) U.S. Cl. CPC B29C 65/344; B29C 65/3476; B29C 66/9121; B29C 66/9141; B29C 73/06

(57) ABSTRACT

A method of repairing a defect of a thermoplastic component is provided. The thermoplastic component has a thermoplastic material at the defect having a first melting temperature, and the defect has a contact surface (TC contact surface). The method includes a) providing a patch comprising a second thermoplastic material having a second melting temperature that is below the first melting temperature. The patch includes a contact surface (TP contact surface); b) disposing a portion of a heating element between the TC contact surface and the TP contact surface. The heating element is operable to heat up as a result of electrical resistance; c) forcing the TP surface toward the TC surface; and d) inputting energy into the heating element to cause the heating element to heat and maintain the TP surface at or above the second melting temperature to produce bonding between the thermoplastic component and the patch.

### BACKGROUND OF THE INVENTION

### 1. Technical Field

The present disclosure relates to methods for repairing thermoplastic components.

### 2. Background Information

Components made from thermoplastic materials are increasingly in demand in the aircraft and other industries as a result of the wide-ranging advantages of the materials. Thermoplastic materials can be used to form lightweight and high-strength structures having complex shapes. In addition, thermoplastic materials, as compared to thermoset materials, offer practically infinite shelf life, faster cycle time, the ability to be recycled/reformed, improved damage tolerance properties, as well as moisture and chemical resistance.

However, widespread adoption of thermoplastic materials in some industries, such as the aircraft industry, has been limited as a result of challenges with thermoplastic component manufacturing and repair. For example, some existing repairs utilize pressure and or heat applied from both sides of the component to be repaired. Very often component geometry will not permit the application of pressure and/or heat applied from both sides. In addition, some current methods of joining thermoplastic components use adhesives or thermoplastic films to join two or more components, thereby forming joints between the two or more components which may exhibit reduced structural strength. Accordingly, improved methods for manufacturing and repairing thermoplastic components which meet industry, safety, airworthiness, and fast throughput requirements are desirable to support industry’s increased production rates.

### SUMMARY OF THE INVENTION

According to an aspect of the present disclosure, a method of repairing a defect region of a thermoplastic component is provided. The thermoplastic component includes a thermoplastic material in the defect region having a first melting temperature, and the defect region has at least one thermoplastic contact surface (TC contact surface). The method includes: a) providing a patch comprising a second thermoplastic material having a second melting temperature that is below the first melting temperature, wherein the patch includes at least one patch contact surface (TP contact surface); b) disposing at least a first portion of a heating element between the at least one TC contact surface and the at least one TP contact surface, the first portion of the heating element having a plurality of perforations, and the heating element operable to increase in temperature as a result of electrical resistance; c) applying a localized force directed to force the at least one TP surface of the patch toward the at least one TC surface of the defect region of the thermoplastic component; and d) inputting an amount of energy into the heating element sufficient to cause the heating element to heat the at least one TP surface to an elevated temperature equal to or above the second melting temperature and to maintain the elevated temperature for a period of time sufficient to produce bonding between the defect region of the thermoplastic component and the patch.

According to another aspect of the present disclosure, a system for repairing a defect region of a thermoplastic component is provided. The thermoplastic component includes a thermoplastic material in the defect region having a first melting temperature, and the defect region has at least one thermoplastic contact surface (TC contact surface). The system includes a patch, a heating element, a heating element energy source, a body, and a controller. The patch includes a second thermoplastic material having a second melting temperature that is below the first melting temperature. The patch includes at least one patch contact surface (TP contact surface). The heating element has a plurality of perforations and is operable to increase in temperature as a result of electrical resistance. The heating element energy source is in communication with the heating element. The heating element energy source is configured to selectively provide electrical energy to the heating element. The body is configured to produce localized force to the patch in a manner that forces the at least one TP surface of the patch toward the at least one TC surface of the defect region of the thermoplastic component. The controller is in communication with the heating element energy source and a non-transitory memory storing instructions. The instructions when executed cause the controller to control the heating element energy source to: a) selectively input electrical energy to the heating element and thereby cause the heating element to produce thermal energy as a result of electrical resistance; b) to cause the heating element to produce an amount of the thermal energy sufficient to heat the at least one TP surface to an elevated temperature equal to or above the second melting temperature and to maintain the elevated temperature for a period of time sufficient to produce bonding between the defect region of the thermoplastic component and the patch; and c) terminate the electrical energy input into the heating element after the period of time.

In any of the aspects or embodiments described above and herein, the at least one TP surface of the patch may be configured to mate with the at least one TC surface of the defect region of the thermoplastic component.

In any of the aspects or embodiments described above and herein, the step of providing the patch may include producing the patch with a geometric configuration that mates with a void in the defect region of the thermoplastic component.

In any of the aspects or embodiments described above and herein, the method may further include preparing the defect region of the thermoplastic component to form the at least one TC surface of the defect region.

In any of the aspects or embodiments described above and herein, the step of preparing the defect region of the thermoplastic component to form the at least one TC surface of the defect region, may include producing a void in the defect region of the thermoplastic component having a first geometric configuration that mates with a second geometric configuration of the patch.

In any of the aspects or embodiments described above and herein, the localized force may be applied to a surface of the patch.

In any of the aspects or embodiments described above and herein, the localized force may be produced by a weighted object resting on the surface of the patch.

In any of the aspects or embodiments described above and herein, the heating element may include a metallic material.

In any of the aspects or embodiments described above and herein, the heating element may include a metallic material configured as a mesh.

In any of the aspects or embodiments described above and herein, the heating element energy source may be configured to selectively directly provide electrical energy to the heating element.

In any of the aspects or embodiments described above and herein, the heating element energy source may be configured to selectively indirectly provide electrical energy to the heating element.

In any of the aspects or embodiments described above and herein, the patch may be configured as a homogeneous body.

In any of the aspects or embodiments described above and herein, the patch may include a plurality of layers.

In any of the aspects or embodiments described above and herein, the step of providing the patch may include stacking individual plies within a void disposed in the defect region of the thermoplastic component, and one or more of the individual plies may be configured to mate with the void disposed in the defect region.

In any of the aspects or embodiments described above and herein, the heating element may include a second portion that is exposed when the at least one TP surface of the patch is forced toward the at least one TC surface of the defect region of the thermoplastic component.

In any of the aspects or embodiments described above and herein, the first portion of the heating element may be configured to mate with a void disposed in the defect region of the thermoplastic component.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a perspective view of an exemplary aircraft nacelle.

FIG. 2 diagrammatically shows a thermoplastic component having a defect region exposed on a surface, and a thermoplastic patch disposed above the defect region.

FIG. 3 shows the thermoplastic component having a defect region and a thermoplastic patch as shown in FIG. 2, and further includes a heating element and an object to provide a localized force.

FIG. 4 diagrammatically illustrates a portion of a thermoplastic component having a defect region (e.g., a crack) exposed on a surface of the thermoplastic component.

FIG. 5 diagrammatically illustrates the portion of a thermoplastic component shown in FIG. 4, now processed for repair and a heating element and a thermoplastic patch.

FIG. 6 diagrammatically illustrates the portion of a thermoplastic component shown in FIG. 5 with the heating element and patch disposed within the prepared defect region with localized force applied.

### DETAILED DESCRIPTION

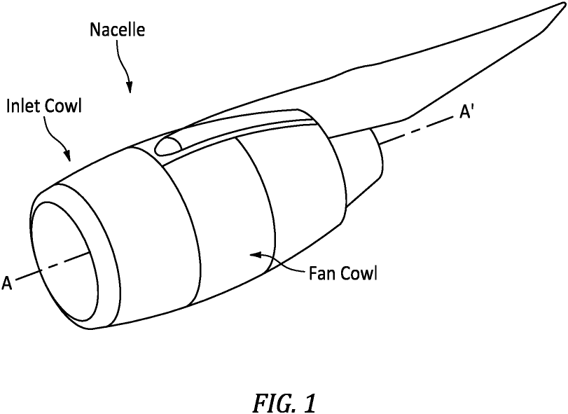

Components made from thermoplastic composite materials are utilized in a variety of different applications, including but not limited to aircraft nacelle components; e.g., nacelle inlet cowls, fan cowls and the like. As may be expected, from time to time these thermoplastic components will have defects produced during manufacturing or incurred during use that would benefit from repair. Aspects of the present disclosure include a new, unobvious method for repairing such thermoplastic components. To facilitate the description herein, the present disclosure repair method will be described in terms of repairing a thermoplastic component of an aircraft nacelle, but the applicability of the present method is not limited to any particular type of thermoplastic component unless otherwise indicated herein. FIG. 1 diagrammatically illustrates an aircraft nacelle having thermoplastic components that may be repaired using the present disclosure repair method; e.g., an inlet cowl and/or a fan cowl. The term “thermoplastic component 20” as used herein includes components that consist entirely of a thermoplastic material, as well as components that do not consist entirely of a thermoplastic material; e.g., a component that comprises at least one thermoplastic element and at least one non-thermoplastic element (e.g., a metallic element, etc.). In the latter instance, the present disclosure repair can be used to repair the thermoplastic element of the multi-element component. The present disclosure method for repairing a thermoplastic component 20 can be used to repair a new thermoplastic component or a used thermoplastic component. A new thermoplastic component, for example, may be formed with a defect (e.g., a region including an undesirable void, or a crack, or a pit, or excess porosity, or a region having an undesirable polymeric constituency, or a delamination, etc., or any combination thereof) or may be damaged during the manufacturing process, which damage produces the aforesaid defect. A used thermoplastic component, on the other hand, may have an area that is worn or eroded over time, or mechanically, thermally, and/or chemically deformed or altered during use, or the like, or any combination thereof. To facilitate the description herein, the term “defect” will be used herein to mean any volumetric region or surface area of a thermoplastic component 20 that a user wishes to remove for any reason (e.g., for structural reasons, for cosmetic reasons, for improvement, or the like) and replaced with a substitute volume of a thermoplastic material (i.e., a “thermoplastic patch 26”), or a worn or eroded area that needs to be rebuilt. The thermoplastic component defect region 22 will be defined by one or more contact surfaces (“TC contact surfaces 24”). The TC contact surfaces 24 define the thermoplastic component defect region 22 as will be described in greater detail below. The maximum acceptable size of a thermoplastic patch 26 likely will be dictated by the thermoplastic component 20; e.g., any thermoplastic patch 26 of a size that does not detrimentally affect the performance or useful life of the thermoplastic component 20 may be considered. As will be described below, the thermoplastic patch 26 may be formed in a variety of different ways.

As will be detailed below, the present disclosure method includes the use of a thermoplastic patch 26 and a heating element 28. During the repair process, the heating element 28 is disposed between the region 22 of the thermoplastic component 20 to be repaired and the thermoplastic patch 26. Present disclosure repair method steps are described hereinafter.

The present disclosure repair method may or may not include a defect region 22 preparation step. In some instances, a defect region 22 of a thermoplastic component 20 may not require any preparation prior to accepting a thermoplastic patch 26. For example, if the defect is a void (e.g., a pit, a crack, a gouge, an indentation, etc.) exposed on a surface of the thermoplastic component 20 and the configuration of the void lends itself to receiving a thermoplastic patch 26 no defect preparation may be needed. In other instances, the defect region 22 of the thermoplastic component 20 may benefit from some amount of preparation prior to accepting a thermoplastic patch 26. For example, the defect region 22 of the thermoplastic component 20 may benefit from a cleaning process that cleans the defect of debris and/or contaminants that will negatively affect the repair process. As another example, a void having a narrow portion (e.g., a narrow crack) may benefit from a preparation process that removes material to open the narrow portion sufficiently to receive thermoplastic patch 26 material and/or to eliminate a crack propagation site. As another example, a void having a portion that is partially covered may benefit from a preparation process that removes material to uncover the covered defect portion to facilitate the receipt of thermoplastic patch 26 material. As another example, a defect region 22 of a thermoplastic component 20 in the form of unacceptable porous material may benefit from a preparation process that removes the porous material. As another example, a defect region 22 of a thermoplastic component 20 containing a delamination may benefit from a preparation process that removes the delaminated portion of the thermoplastic component 20. In some instances, the preparation process may include altering the surface properties of the defect (e.g., smooth a rough surface or roughen a smooth surface) to facilitate the repair process. The present disclosure is not limited to any particular process for preparing the defect for the repair process and the particular preparation process(es) may vary depending on the material of the thermoplastic component 20 and the nature of the defect. In some instances, the preparation process may include a plurality of steps; e.g., a first cleaning, a material removal process, a surface preparation process, a final cleaning, etc. The above preparation process examples are provided as illustrative examples and the present disclosure is not limited to these particular preparation processes. The thermoplastic patch 26, regardless of its geometric configuration, includes one or more surfaces (“TP contact surfaces”; e.g., see TP contact surfaces 30 shown in FIG. 5) that are placed in close proximity to the TC contact surfaces 24 during the repair.

A thermoplastic component 20 repairable under the present disclosure may comprise a variety of different thermoplastic materials. As stated above, thermoplastic components are used in a variety of different applications that dictate different mechanical strength requirements, rigidity or flexibility requirements, thermal environment requirements, or the like, or any combination thereof. Hence, the material comprising the thermoplastic component 20 is chosen to satisfy those requirements. The present disclosure repair process may be used with a wide variety of such thermoplastic materials and therefore has broad applicability. In terms of an aircraft nacelle component, low melt (LM) polyaryletherketone (“PAEK”) and polyether ether ketone (“PEEK”) are nonlimiting examples of thermoplastic materials that may be used within a thermoplastic component 20.

The thermoplastic patch 26 may comprise one or more thermoplastic materials. The thermoplastic material(s) comprising the thermoplastic patch 26 preferably, but not necessarily, has a lower melting temperature than the material of the thermoplastic component defect region 22 to be repaired. For example, if the thermoplastic component defect region 22 comprises a first melting temperature (e.g., X°C), then a thermoplastic patch 26 may comprise a thermoplastic material having a second melting temperature (e.g., Y°C) lower than the first melting temperature (i.e., X > Y). As a specific non-limiting example, if the material of the thermoplastic component defect region 22 to be repaired comprises a PAEK or PEEK polymer (melt temperature ~ 350° C.), then a thermoplastic patch 26 may comprise a thermoplastic material such as polyphenylene sulfide (“PPS″ - melt temperature ~ 280° C.). In some embodiments, the thermoplastic patch 26 may comprise the same material as the thermoplastic component 20. For example, a thermoplastic patch 26 comprising the same material as the thermoplastic component 20 may be heat treated so that its solid state is less semi-crystalline that the thermoplastic component 20, or alternatively has an amorphous structure. A thermoplastic patch 26 with a semi-crystalline or amorphous structure can be configured as conformable relative to the defect region 22 and will “flow” relative to the geometry of the defect region 22 to create intimate contact there between. The solid state for the thermoplastic patch can be enforced by quenching the thermoplastic patch 26 from the melt after thermoforming the patch 26. In some embodiments, a dissolved thermoplastic material may be disposed between defect region 22 and the thermoplastic patch 26 to facilitate filling the interface between the damage region 22 and the thermoplastic patch 26. The present disclosure is not limited to any particular type of thermoplastic patch 26 material. In some embodiments, the material of the thermoplastic patch 26 may be chosen in view of the material of the thermoplastic component defect region 22 to be repaired. For example, if the material of the thermoplastic component defect region 22 to be repaired is a homogenous material (e.g., unlayered), then the thermoplastic patch 26 may be configured as a homogenous material. As another example, if the material of the thermoplastic component defect region 22 to be repaired is a layered composite, then the thermoplastic patch 26 may be configured as a layered composite; e.g., a stack of layers that is acceptable (layer thicknesses, materials, orientation, etc.) in view of the layered configuration of the defect region 22. Thermoplastic patches 26 according to the present disclosure are not limited to any particular configuration; e.g., layered, unlayered, homogenous, fiber-reinforced, etc.

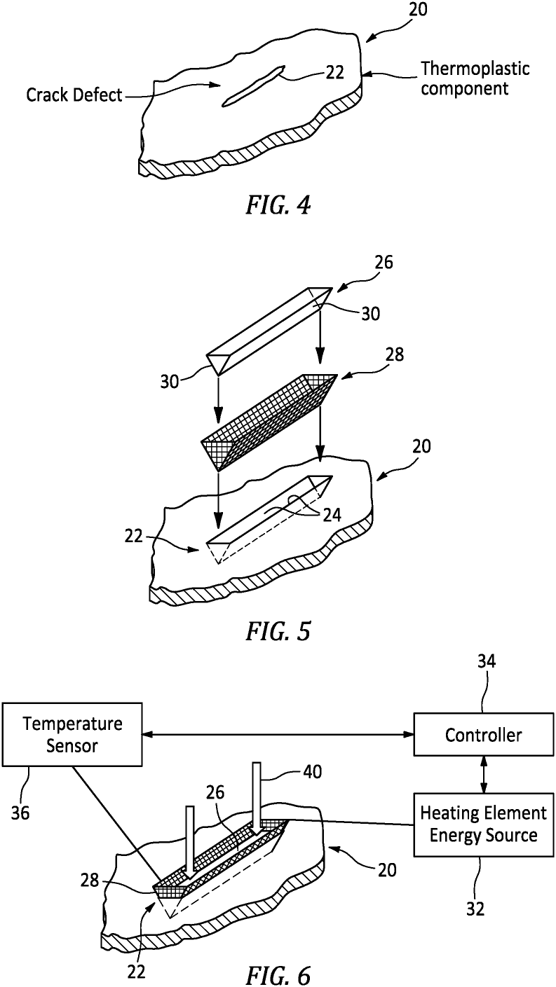

In those instances where the defect region 22 of the thermoplastic component 20 to be repaired is a void, the geometric configuration of the thermoplastic patch 26 is typically chosen to entirely fill the void and thereby enable the surface of the thermoplastic component 20 being repaired to be returned to a continuous surface. In some embodiments, the thermoplastic patch 26 may be prepared with a geometric configuration that mates with the geometric configuration of the defect region 22 of the thermoplastic component 20 to be repaired. For example, and referring to FIGS. 4-6, if the defect region 22 of the thermoplastic component 20 to be repaired has a “V” shape that extends a lengthwise distance, the thermoplastic patch 26 may be geometrically configured with a V-shape and a length that can be received within and that mates with the V-shaped defect region 22 of the thermoplastic component 20. As another example, if the defect region 22 of the thermoplastic component 20 to be repaired has a semi-circular shape that extends a lengthwise distance, the thermoplastic patch 26 may be geometrically configured with a semi-circular shape and a length that can be received within and that mates with the semi-circular shaped defect region 22 of the thermoplastic component 20. As yet another example, if the defect region 22 of the thermoplastic component 20 to be repaired has a partial spherical shape, the thermoplastic patch 26 may be geometrically configured with a partial spherical shape that can be received within and that mates with the semi-circular shaped defect region 22 of the thermoplastic component 20. The above examples of thermoplastic geometric configuration are provided to illustrate the present disclosure and the present disclosure is not limited thereto. In those embodiments where the thermoplastic patch 26 is intended to fill a void, the thermoplastic patch 26 mating geometry may account for the geometry (e.g., the thickness) of the heating element 28 that will be disposed between the thermoplastic patch 26 and the defect region 22; e.g., because some amount of the patch material will likely migrate through apertures/perforations of the heating element 28 during the repair process (as will be described below), the thermoplastic patch 26 may be slightly oversized to ensure the void is entirely filled upon completion.

In some instances, the geometric configuration of the thermoplastic patch 26 used to fill a void may be specifically tailored to a uniquely configured void geometry. In other instances, thermoplastic patches 26 may be prepared with predetermined (i.e., “stock”) geometric configurations that can be used for regularly occurring voids shapes, or a preparation process may be utilized to prepare the void to have a geometry that mates with a predetermined patch 26 configuration. In some embodiments, the thermoplastic patch 26 may not be pre-formed but may rather be “assembled” within the defect region 22, for example by stacking individual plies of patch material collectively geometrically configured to produce the desired patch 26 configuration.

In some instances where the defect region 22 of the thermoplastic component 20 to be repaired is a shallow depression, or a worn or eroded area that needs to be rebuilt, or the like, an acceptable thermoplastic patch 26 may be used that has a generic geometric configuration; e.g., a stock geometric configuration that upon application of force fills the shallow depression, or that provides the requisite material necessary to rebuild the worn or eroded region 22. After the repair is completed, any excess material of the stock patch 26 configuration can be removed.

In some embodiments, the present disclosure repair method includes disposing a heating element 28 between the TC contact surfaces 24 and the TP contact surfaces 30. The heating element 28 is operable to produce sufficient thermal energy to raise at least a portion of the thermoplastic patch 26 to an elevated temperature sufficient to permit bonding between the TC contact surfaces 24 and the TP contact surfaces 30. The heating element 28 has a perforated (or porous) configuration that allows the passage of thermoplastic patch material to migrate through the perforations (openings) in the heating element 28 and into contact with the TC contact surfaces 24 defining the defect region 22. A screen-like (e.g., a mesh, a scrim, or the like) material is a non-limiting example of a material that may be used to form the heating element 28. The heating element 28 may be configured to produce thermal energy as a result of direct electrical energy input or as a result of electromagnetic field input into the heating element 28, either of which inputs produces thermal energy due to electrical resistance within the heating element 28. The energy input may be provided by a heating element energy source 32; e.g., configured to produce the electrical energy input directly to the heating element 28 or the electromagnetic field input indirectly into the heating element 28. The energy input to the heating element 28 that produces the thermal energy may be manually controlled or controlled in an automated manner. The heating element 28 may be comprised of a metallic material that produces the desired resistance thermal energy output as a result of the aforesaid energy input. Non-limiting examples of heating element 28 materials that may be used include stainless steel and copper. In some embodiments, the heating element 28 may be comprised of a non-metallic material or a composite material having a non-metallic matrix that includes elements (e.g., carbon fibers and the like) that may produce the desired resistance thermal energy output as a result of the aforesaid energy input. Preferably, the heating element material is non-reactive with the thermoplastic component 20 material and the thermoplastic patch material, and also substantially inert with any other elements to which the heating element 28 may be exposed during the repair process or in the environment in which the repaired thermoplastic component 20 is designed to be used. The heating element 28 may be pre-conformed to mate with the TC contact surfaces 24 defining the defect region 22 or may be sufficiently flexible to conform to the TC contact surfaces 24 defining the defect region 22, or some combination thereof. In some embodiments, the thermal energy used to join the thermoplastic patch 26 and the defect region 22 of the thermoplastic component 20 together may be provided by an electrically powered and/or an electromagnetically activated heating structure (e.g., a heating blanket). In some embodiments, the present disclosure repair process may utilize one or more caul plates/elements to facilitate the formation of a desired thermoplastic surface (e.g., an aerodynamic surface) as part of the repair process.

In those instances where the energy input into the heating element 28 is controlled in an automated manner, a controller 34 may be used to control the energy output from the heating element energy source 32 into the heating element 28, the rate at which the heating element 28 is heated, the duration that the heating element 28 is used to produce thermal energy, and any other operational parameters that may be applicable. The controller 34 is in communication with heating element energy source 32 and depending on the present disclosure system configuration, may also be in communication with one or more temperature sensors 36 configured to directly or indirectly sense the temperature at the interface between the patch 26 and the thermoplastic component 20, or the heating element 28, or both, a timer, and the like to control and or receive signals therefrom to perform the functions described herein. The controller 34 may include any type of computing device, computational circuit, processor(s), CPU, computer, or the like capable of executing a series of instructions that are stored in memory. The controller 34 may be configured as hardware or software or any combination thereof. The instructions may include an operating system, and/or executable software modules such as program files, system data, buffers, drivers, utilities, and the like. The executable instructions may apply to any functionality described herein to enable the system to accomplish the same algorithmically and/or coordination of system components. The controller 34 may include a single memory device or a plurality of memory devices and the present disclosure is not limited to any particular type of memory device.

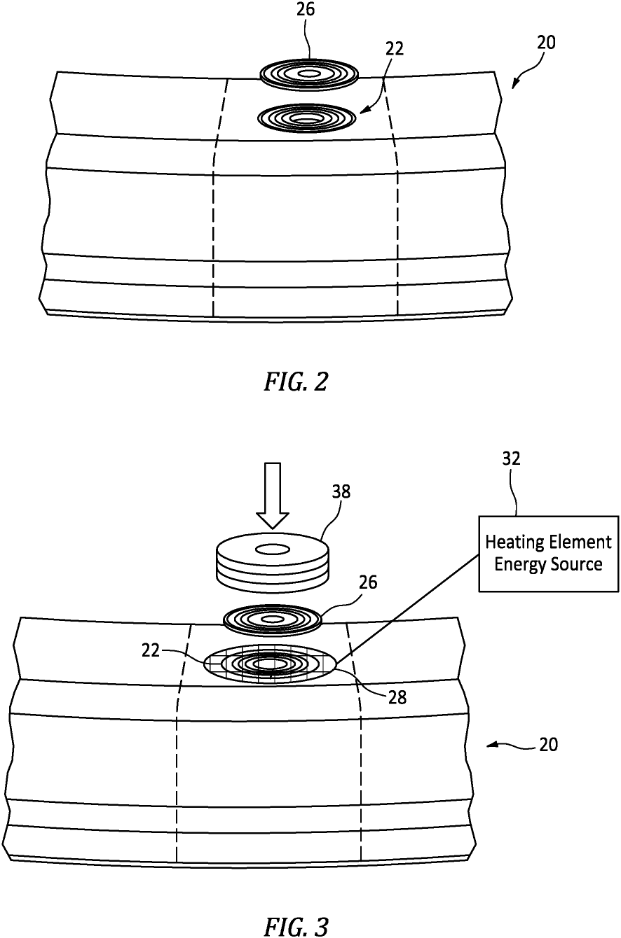

A first example of the present disclosure repair method may be described using the thermoplastic component 20 shown in FIGS. 2 and 3. Referring to FIG. 2, a thermoplastic component 20 is shown having a defect region 22 exposed on a surface of the thermoplastic component 20. The defect region 22 is shown diagrammatically with a centrally located void and a shallow depression area disposed around the centrally located void. As stated above, pursuant to the present disclosure method the defect region 22 may have been subjected to preparation steps such as initially cleaning the defect region 22 to remove debris and/or contaminants, removal of material to open up the centrally located void and surrounding area to facilitate the receipt of thermoplastic patch material, surface preparation (e.g., smoothing or roughening the contact surfaces of the defect region 22), and a final cleaning step to remove debris and/or contaminants from the defect region 22. FIG. 2 illustrates a thermoplastic patch 26 sized to mate with the defect region 22 disposed above the defect region 22 to illustrate the relative geometric configurations. FIG. 3 diagrammatically illustrates the thermoplastic component 20 with the defect region 22 in form for repair, and a thermoplastic patch 26 and heating element 28 disposed above and aligned with the defect region 22. A weighted object 38 (e.g., a plurality of weighted rings) is shown disposed above the thermoplastic patch 26 to apply localized force to the patch 26 and the heating element 28. Hence, the aforesaid elements are shown in an exploded stacked arrangement above the defect region 22: the weighted object 38 above the thermoplastic patch 26 and the patch 26 above the heating element 28, and all aligned with the defect region 22. To perform the repair, the heating element 28 and the patch 26 are placed in contact with the defect region 22 and the weighted object 38 is placed in contact with the patch 26 to apply localized force pressing the patch 26 and heating element 28 into contact with the TC contact surfaces 24. In some embodiments a sheet of release material (not shown) may be disposed between the weighted object 38 and the thermoplastic patch 26 to prevent attachment there between. The weighted object 38 is a non-limiting example of how a localized force may be applied to the thermoplastic patch 26 during the repair process. In some embodiments, a vacuum bag may be used to apply force to the thermoplastic patch 26 during the repair process. As stated above, the heating element 28 may be pre-conformed to mate with the TC contact surfaces 24 defining the defect region 22 or may be sufficiently flexible to conform to the TC contact surfaces 24 upon application of localized force, or some combination thereof. The weight of the weighted object 38 may be chosen to produce sufficient localized force to ensure intimate contact between the TC contact surfaces 24, the heating element 28, and the TP contact surfaces 30 of the patch 26. The heating element 28 may also be configured larger than the defect region 22 to expose a portion of the heating element 28 above the defect region 22. The exposed portion of the heating element 28 may facilitate the connection of the heating element 28 to the heating element energy source 32 during the joining process. The heating element energy source 32 is controlled to cause the heating element 28 to produce thermal energy which in turn raises the temperature of the TC contact surfaces 24 and the TP contact surfaces 30. More specifically, the heating element 28 is controlled to raise the temperature of the TC contact surfaces 24 and the TP contact surfaces 30 to a point where the TC contact surfaces 24 and the TP contact surfaces 30 bond with one another. In those embodiments where the thermoplastic patch 26 has a lower melting temperature, the heating element 28 raises the temperature of the TP contact surfaces 30 to at least the melting temperature of the patch material. As the patch material local to the TP contact surfaces 30 melts, patch material migrates through the perforations in the heating element 28 (e.g., through the screen) and into contact with the TC contact surfaces 24 defining the defect region 22. The heating element 28 is maintained at a temperature for a time period adequate for bonding to occur between the thermoplastic patch 26 and the thermoplastic component 20. Once sufficient bonding has occurred, the energy source 32 is controlled to cease heating of the heating element 28 and the repaired defect region 22 is allowed to cool. After sufficient cooling, the weighted object 38 is removed. In some instances, the repaired defect region 22 may be subject to post-repair processing to remove any excess patch material that may exist as well as any exposed heating element 28 and thereby leave a repaired region 22 that conforms with the surrounding surfaces of the thermoplastic component 20.

A second example of the present disclosure repair method may be described using the thermoplastic component 20 shown in FIGS. 4-6. Referring to FIG. 4, a thermoplastic component 20 is shown having a defect region 22 (e.g., a crack) exposed on a surface of the thermoplastic component 20. In this example, the defect region 22 is processed to remove the entirety of the crack and to open up the void to facilitate the receipt of thermoplastic patch material, and subsequently cleaned to remove debris and/or contaminants from the defect region 22. FIG. 5 diagrammatically illustrates the defect region 22 processed to receive the heating element 28 and the thermoplastic patch 26, and a heating element 28 and patch 26 disposed above and aligned with the prepared defect region 22. FIG. 6 illustrates the heating element 28 and patch 26 disposed within the prepared defect region 22 with localized force 40 diagrammatically applied. As stated above, the heating element 28 may be pre-formed to mate with the TC contact surfaces 24 or may be sufficiently flexible to conform to the TC contact surfaces 24 upon application of localized force 40, or some combination thereof. Also as stated above, the void may be prepared with a “stock” configuration to permit the use of a predetermined/stock patch 26 geometry.

Sufficient localized force 40 is applied to ensure intimate contact between the TC contact surfaces 24, the heating element 28, and the TP surfaces of the patch 26. The heating element 28 is shown as being larger than the defect region 22 to expose a portion of the heating element 28 above the defect region 22 and to ensure the presence of heating element 28 between all of the TC contact surface 24 and TP contact surface interfaces. The exposed portion of the heating element 28 is in communication with the heating element energy source 32. In this example, the heating element energy source 32 is in turn in communication with a controller 34 and the controller 34 is in communication with a temperature sensor 36. The stored instructions accessible by the controller 34 may include data relating sensed temperature and thermoplastic patch material melting temperatures, and the amount of time necessary to produce the desired bonding between the TC contact surfaces 24 of the defect region 22 and the TP contact surfaces 30 of the patch 26. Hence, the controller 34 may be utilized to automate at least portions of the repair process. The heating element energy source 32 is controlled to cause the heating element 28 to produce sufficient thermal energy to raise the temperature of the TC contact surfaces 24 and the TP contact surfaces 30 to a point where the TC contact surfaces 24 and the TP contact surfaces 30 bond with one another. Once sufficient bonding has occurred, the energy source 32 is controlled to cease heating of the heating element 28 and the repaired defect region 22 is allowed to cool. After sufficient cooling, the localized force 40 is removed. The repaired defect region 22 may then be subject to post-repair processing to remove any excess patch material that may exist as well as any exposed heating element 28 and thereby leave a repaired region 22 that conforms with the surrounding surfaces of the thermoplastic component 20.

As is evident from the description above, the present disclosure method provides a repair of a thermoplastic component 20 that does not utilize any additional material at the interface between the thermoplastic patch 26 and the thermoplastic component defect region 22; e.g., no adhesives, composite fillers, films, or coatings, or the like that increase the difficulty and/or cost of the repair, and that may provide a failure mechanism if improperly executed. At least a portion of the heating element 28 remains at the interface between the TC contact surfaces 24 and the TP contact surfaces 30, but the bond between the TC contact surfaces 24 and the TP contact surfaces 30 is direct. In addition, the present disclosure repair method only utilizes a localized force applied from a single direction. Hence, the present disclosure method may be utilized in those applications wherein it is not possible or is burdensome to apply force from opposite sides of the thermoplastic patch 26 and the thermoplastic component defect region 22 interface.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A method of repairing a defect region of a thermoplastic component, which thermoplastic component comprises a thermoplastic material in the defect region having a first melting temperature, wherein the defect region of a thermoplastic component has at least one thermoplastic contact surface (TC contact surface), the method comprising:
providing a patch comprising a second thermoplastic material having a second melting temperature that is below the first melting temperature, wherein the patch includes at least one patch contact surface (TP contact surface);
disposing at least a first portion of a heating element between the at least one TC contact surface and the at least one TP contact surface, the first portion of the heating element having a plurality of perforations, and the heating element operable to increase in temperature as a result of electrical resistance;
applying a localized force directed to force the at least one TP surface of the patch toward the at least one TC surface of the defect region of the thermoplastic component; and
inputting an amount of energy into the heating element sufficient to cause the heating element to heat the at least one TP surface to an elevated temperature equal to or above the second melting temperature and to maintain the elevated temperature for a period of time sufficient to produce bonding between the defect region of the thermoplastic component and the patch.

2. The method of claim 1, wherein the at least one TP surface of the patch is configured to mate with the at least one TC surface of the defect region of the thermoplastic component.

3. The method of claim 2, wherein the step of providing the patch includes producing said patch with a geometric configuration that mates with a void in the defect region of the thermoplastic component.

4. The method of claim 1, wherein the method further includes preparing the defect region of the thermoplastic component to form the at least one TC surface of the defect region.

5. The method of claim 4, wherein the step of preparing the defect region of the thermoplastic component to form the at least one TC surface of the defect region, includes producing a void in the defect region of the thermoplastic component having a first geometric configuration that mates with a second geometric configuration of the patch.

6. The method of claim 1, wherein the localized force is applied to a surface of the patch.

7. The method of claim 6, wherein the localized force is produced by a weighted object resting on the surface of the patch.

8. The method of claim 1, wherein the heating element comprises a metallic material.

9. The method of claim 8, wherein the heating element comprises a metallic material configured as a mesh.

10. The method of claim 1, wherein the step of inputting an amount of energy into the heating element utilizes a heating element energy source that selectively directly provides electrical energy to the heating element.

11. The method of claim 1, wherein the step of inputting an amount of energy into the heating element utilizes a heating element energy source that selectively indirectly provides electrical energy to the heating element.

12. The method of claim 1, wherein the patch comprising the second thermoplastic material is configured as a homogeneous body.

13. The method of claim 1, wherein the patch comprising the second thermoplastic material includes a plurality of layers.

14. The method of claim 1, wherein the step of providing the patch includes stacking individual plies within a void disposed in the defect region of the thermoplastic component.

15. The method of claim 14, wherein one or more of the individual plies is configured to mate with the void disposed in the defect region.

16. The method of claim 1, wherein the heating element includes a second portion that is exposed when the at least one TP surface of the patch is forced toward the at least one TC surface of the defect region of the thermoplastic component.

17. The method of claim 1, wherein the first portion of the heating element is configured to mate with a void disposed in the defect region of the thermoplastic component.

18. A system for repairing a defect region of a thermoplastic component, which thermoplastic component comprises a thermoplastic material in the defect region having a first melting temperature, wherein the defect region of a thermoplastic component has at least one thermoplastic contact surface (TC contact surface), the system comprising:
a patch comprising a second thermoplastic material having a second melting temperature that is below the first melting temperature, wherein the patch includes at least one patch contact surface (TP contact surface);
a heating element having a plurality of perforations, the heating element operable to increase in temperature as a result of electrical resistance;
a heating element energy source in communication with the heating element, the heating element energy source configured to selectively provide electrical energy to the heating element;
a body configured to produce localized force to the patch in a manner that forces the at least one TP surface of the patch toward the at least one TC surface of the defect region of the thermoplastic component; and
a controller in communication with the heating element energy source and a non-transitory memory storing instructions, which instructions when executed cause the controller to control the heating element energy source to:
selectively input electrical energy to the heating element and thereby cause the heating element to produce thermal energy as a result of electrical resistance;
cause the heating element to produce an amount of the thermal energy sufficient to heat the at least one TP surface to an elevated temperature equal to or above the second melting temperature and to maintain the elevated temperature for a period of time sufficient to produce bonding between the defect region of the thermoplastic component and the patch; and
terminate the electrical energy input into the heating element after the period of time.
